(19) United States
(12) Patent Application Publication
(10) Pub. No.: US 2014/0094228 A1
(43) Pub. Date: Apr. 3, 2014

(54) VEHICLE HANDS FREE TELEPHONE SYSTEM WITH ACTIVE NOISE CANCELLATION

(71) Applicants: Lawrence Robert Hamelink, Holland, MI (US); Brian K. Servis, Holland, MI (US); Kevin J. Blauwkamp, Zeeland, MI (US)

(72) Inventors: Lawrence Robert Hamelink, Holland, MI (US); Brian K. Servis, Holland, MI (US); Kevin J. Blauwkamp, Zeeland, MI (US)

(73) Assignee: Johnson Controls Technology Company

(21) Appl. No.: 14/118,884

(22) PCT Filed: May 18, 2012
(86) PCT No.: PCT/US2012/038683

§ 371 Date: Nov. 19, 2013

Related U.S. Application Data
(60) Provisional application No. 61/488,664, filed on May 20, 2011.

(51) Int. Cl. H04M 1/60

(52) U.S. Cl. CPC H04M 1/6091
USPC 455/569.2

(57) ABSTRACT

A vehicle telephone device for mounting in a vehicle and for use with a vehicle audio system, a microphone mounted in the vehicle, and a mobile phone is disclosed. The vehicle telephone device includes a housing and a telephone module within the housing and configured to use the mobile phone, the microphone, and the vehicle audio system to provide an in-vehicle telephone feature. The vehicle telephone device further includes an active noise cancellation module within the housing and is configured to use the vehicle audio system to cancel noise in the vehicle.

### CROSS-REFERENCE TO RELATED APPLICATIONS

This application claims the benefit of and priority to U.S. Appl. No. 61/488,664, filed May 20, 2011, the entirety of which is incorporated by reference herein.

### BACKGROUND

The present invention relates generally to the field of vehicle-based telephone systems.

Vehicles (automobiles, trucks, buses, etc.) can include a vehicle-based telephone module. Vehicle-based telephone modules conventionally include an input for a microphone, communications electronics (e.g., a transceiver for connecting to a mobile phone, an embedded phone, etc.), an output to a stereo system, and other inputs and outputs (e.g., an interface to a user input device, an output interface for a display). Such vehicle-based telephone modules might be referred to as hands-free telephone (HFT) modules. Some vehicles include a noise cancellation module that exists separately from the vehicle-based telephone module. Conventionally, such a noise cancellation module does not operate in concert with the vehicle-based telephone module. Conventional thought in the automotive industry is that such systems must be separate to achieve performance gains from the provision of dedicated circuits.

### SUMMARY

One embodiment of the present disclosure relates to a vehicle telephone device for mounting in a vehicle. The vehicle telephone device is for use with a vehicle audio system, a microphone mounted in the vehicle, and a mobile phone. The vehicle telephone device includes a housing. The vehicle telephone device further includes a telephone module within the housing and is configured to use the mobile phone, the microphone, and the vehicle audio system to provide an in-vehicle telephone feature. The vehicle telephone device further includes an active noise cancellation module within the housing and is configured to use the vehicle audio system to cancel noise in the vehicle.

Another embodiment of the present disclosure relates to a vehicle system. The vehicle system includes a vehicle audio system, at least one microphone, a device including a housing, an interface to the vehicle audio system, and an interface to the at least one microphone. The device further includes electronics within the housing. The electronics include a hands-free telephone module and an active noise cancellation module.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is an environment view of a vehicle with a telematics system, according to an exemplary embodiment;

FIG. 2 is a block diagram of the telematics system of FIG. 1, according to an exemplary embodiment;

FIG. 3 is a block diagram of the vehicle telephone device of FIG. 2, according to an exemplary embodiment;

FIG. 4 is a block diagram of the vehicle telephone device of FIG. 2, according to another exemplary embodiment;

FIG. 5 is a block diagram of the vehicle telephone device of FIG. 2, according to another exemplary embodiment;

FIG. 6 is a block diagram of the vehicle telephone device of FIG. 2, according to another exemplary embodiment; and

FIG. 7 is a flow chart of an active noise cancellation process of the vehicle telephone device of FIG. 2, according to an exemplary embodiment.

### DESCRIPTION

Referring generally to the Figures, a vehicle telephone module is shown as integrated with an active noise cancellation module. The vehicle telephone module and the active noise cancellation module may operate together to provide for an improved user experience, improved telephone system performance, and/or improved active noise cancellation performance. The vehicle telephone module and the active noise cancellation module may be contained in the same housing (e.g., in a vehicle telephone device). Such integration may save cost, size (e.g., package dimensions), and weight. Such integration may also provide for enhanced functionality of the telephone system and the active noise cancellation module.

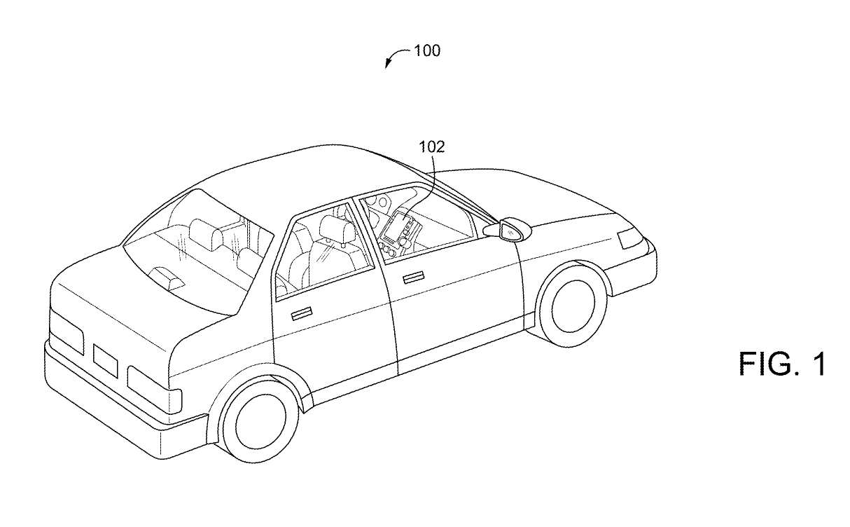

With reference to FIG. 1, embodiments of the invention relate to a telematics system 102 for a vehicle 100. Telematics system 102 may include any number of displays (e.g., LCD displays, touch screen displays, etc.) and any number of user interface elements (e.g., buttons, switches, touch screen elements for selection, dials, joysticks, steering-wheel mounted controls, etc.). Telematics system 102 may include communications features (e.g., BLUETOOTH phone connectivity provided by an HFT module, an embedded telephone module, garage door communications systems such as HOMELINK sold by Johnson Controls, etc.), user comfort and convenience features, safety features, entertainment features such as radio, or other user interfacing features.

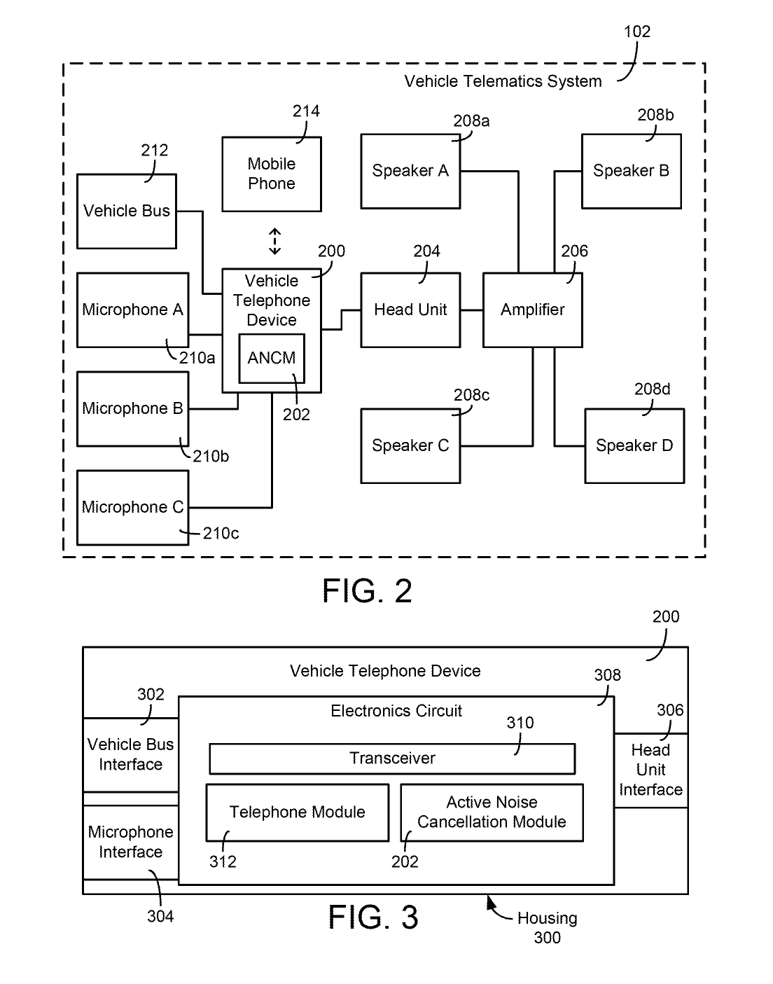

Referring now to FIG. 2, a block diagram of telematics system 102 partially shown in FIG. 1 is shown, according to an exemplary embodiment. Telematics system 102 of FIG. 2 is shown to include a vehicle telephone device 200. Vehicle telephone device 200 includes an active noise cancellation module (ANCM) 202. Vehicle telephone device 200 also includes circuitry and software for providing HFT features (e.g., hands-free dialing, connectivity to a mobile phone, text-to-speech features, voice recognition, etc.).

Active noise cancellation module 202 is configured to process microphone inputs to determine audio outputs for canceling noise in the vehicle cabin. The phrase active noise cancellation module is used throughout this disclosure, but may also be referred to as active noise reduction (ANR) or antinoise. Active noise cancellation module 202 can determine a noise component to audio received at a connected microphone. Active noise cancellation module 202 then generates an audio signal calculated to result in audio output (i.e., a sound wave) having an inverted phase (i.e., antiphase) relative to the determined noise component.

Vehicle telephone device 200 includes a connection to a head unit 204 in vehicle 100. Head unit 204 in vehicle 100 may include a radio tuner, navigation features, volume control features, audio source selection features, display features, or other user interface features. Head unit 204 may pass audio signals (e.g., in analog form, in digital form, etc.) from vehicle telephone device 200 to the amplifier 206. Amplifier 206 is configured to decode (e.g., in the case of digital signals) and amplify the audio signals received from head unit 204. Amplifier 206 provides the amplified signals to one or more speakers (e.g., speakers 208a, 208b, 208c, 208d) located in the vehicle cabin. Speakers 208a, 208b, 208c, 208d may be located at varying locations in the cabin.

According to an exemplary embodiment, one or both of head unit 204 and vehicle telephone device 200 can include human machine interface (HMI) modules, navigation system modules, voice recognition system modules, user input device modules, additional connectivity modules, and/or other modules for affecting the user interface experience with vehicle 100 (e.g., an HVAC module). All such modules or features may be added to the vehicle telephone module described herein and remain within the scope of some embodiments of the present disclosure. In an alternative embodiment, the position of head unit 204 and vehicle telephone device 200 may be swapped with respect to the audio system. For example, head unit 204 may be upstream of vehicle telephone device 200 and active cancellation module 202. In such an embodiment, head unit 204 may include a navigation feature and/or the primary HMI features of vehicle 100 while vehicle telephone device 200 is configured to cause and control the HFT features and the noise cancellation features.

In the illustration of FIG. 2, vehicle telephone device 200 is shown as coupled to three microphones 210a, 210b, 210c. Microphones 210a, 210b, 210c may be of the same type or varying types or technologies (e.g., electromagnetic induction, dynamic, capacitance change, condenser, piezoelectric generation, light modulation of mechanical vibration, hypo-cardioids, omni-directional, uni-directional, etc.).

Vehicle telephone device 200 is also shown as connectively coupled to a vehicle bus 212. Vehicle bus 212 can provide signals from the vehicle's engine control module (ECM), body control module (BCM), or other vehicle subsystems (e.g., an electronic window/door control subsystem).

During mobile phone communications, the illustrated mobile phone 214 can be connected (e.g., wirelessly, via a wire or wires) to vehicle telephone device 200 for data communications. Vehicle telephone device 202 can use the cellular or mobile communications features of mobile phone 214 to provide data or voice communications to the interior of vehicle 100. Audio received from mobile phone 214 is caused to be played back over the vehicle's audio system (e.g., including head unit 204, amplifier 206, and speakers 208a, 208b, 208c, 208d). Further, vehicle telephone device 200 can receive audio (e.g., speech) at one or more of microphones 210a, 210b, 210c and provide such audio to mobile phone 214 via the wireless or wired data communications with mobile phone 214.

With the integration of the telephony features and active noise cancellation module 202 within vehicle telephone device 200, vehicle telephone device 200 can provide improved active noise cancellation during use of mobile phone 214. Active noise cancellation module 202 can also provide for noise cancellation functions during times when the vehicle telephone features are not active (e.g., during normal driving). Regardless of the timing, active noise cancellation module 202 can be used to help suppress wind noise, engine noise, road noise, braking noise, or any other type of low frequency, medium frequency and/or high frequency background noise.

The improved active noise cancellation may be provided by close communications and/or feedback between vehicle telephone device 200 and active noise cancellation module 202. For example, vehicle telephone device 200 can inform the active noise cancellation module 202 that a telephone conversation is occurring. In such an embodiment or other embodiments, vehicle telephone device 200 can provide audio signals of the telephone conversation to active noise cancellation module 202 so that active noise cancellation module 202 can make adjustments that do not cancel, for example, a deep voice forming a part of the telephone conversation. Vehicle telephone device 200 may provide active noise cancellation module 202 with timing information, frequency range information, and actual audio signals of the phone conversation for use, may identify a microphone being utilized by the telephone feature, etc.

According to an exemplary embodiment, active noise cancellation module 202 can receive information (e.g., information regarding cylinder activation/deactivation, information regarding engine RPMs, information regarding vehicle speed, information regarding acceleration, etc.) received from the vehicle bus 212, ECM, or other body control module to predict noise. Active noise cancellation module 202 may then use the predicted noise to increase, decrease, or change noise cancellation activities or parameters (e.g., during normal driving, during a telephone conversation). Further, using the close coupling of active noise cancellation module 202 and vehicle telephone device 200, vehicle telephone device 200 can suppress, filter, or remove noise received at the microphones 210a, 210b, 210c (e.g., the primary hands-free telephone microphone) so that such noise is not communicated as a part of the telephone conversation (e.g., so that such noise is not transmitted to a mobile telephone for use in the telephone call).

In an exemplary embodiment, vehicle 100 is configured to include a speaker for each seating location. Active noise cancellation device 202 may be configured to provide different noise cancellation signals to the vehicle seats depending on whether or not a telephone conversation is occurring. For example, while a telephone conversation is occurring, active noise cancellation module 202 may be configured to calculate speaker output for each speaker (e.g., speakers 208a, 208b, 208c, 208d) that is configured to provide the best noise cancellation for the driver seat (or another user actively using the telephone system). When the telephone conversation is complete, active noise cancellation module 202 may be configured to switch from focusing noise cancellation efforts of each speaker on the driver's noise levels to distributing the noise cancellation efforts to each seat.

Referring now to FIG. 3, a block diagram view of the vehicle telephone device of FIG. 2 is illustrated, according to an exemplary embodiment. Vehicle telephone device 200 is shown to include a vehicle bus interface 302. Vehicle bus interface 302 can be or include any number of jacks, wire terminals, wire leads, ports, plugs, receptacles or other structures for connecting a wire or wires of vehicle bus 212 to vehicle telephone device 200. Vehicle bus interface 302 can also include circuitry (e.g., filters, converters, decoders, etc.) for sending and/or receiving communications to/from vehicle bus 212. Vehicle bus 212 may be a CAN bus, a LIN bus, an Ethernet bus, or another type of vehicle bus.

Vehicle telephone device 200 is also shown to include a microphone interface 304. Microphone interface 304 may be or include any number of jacks, wire terminals, wire leads, ports, plugs, receptacles, or other structures for connecting a wire or wires of a microphone (e.g., microphones 210a, 210b, 210c) to vehicle telephone device 200. Vehicle telephone device 200 is further shown to include a head unit interface 306. Head unit interface 306 may also be or include any number of jacks, wire terminals, wire leads, ports, plugs, receptacles, or other structures for connecting vehicle telephone device 200 to vehicle audio system head unit 204.

An electronics circuit 308 is contained within the vehicle telephone device's housing 300. Housing 300 may be a single piece housing, a multi-piece housing, constructed of plastic or any other material, or may be otherwise constructed. Housing 300 is shown to include an electronics circuit 308 connected to vehicle bus interface 302, microphone interface 304, and vehicle head unit interface 306. Electronics circuit 308 may be one or more printed circuit boards, point-to-point wirings of electronic components, a flexible circuit, another type of circuit, or a combination thereof.

Electronics circuit 308 is shown to include a transceiver 310. Transceiver 310 can be a BLUETOOTH transceiver configured to communicate via short-range wireless data communications to a mobile phone (e.g., mobile phone 214) carried or placed within the vehicle cabin. In other embodiments, transceiver 310 can be of any other wired or wireless technology or protocol. The mobile phone can connect to a cellular tower or remote communications station to effect voice communications. Data for the voice communications can be sent to and received from transceiver 310. Transceiver 310 may alternatively be any other type of transceiver, including, for example, an embedded cellular/mobile phone transceiver for effecting mobile phone communications with a cellular tower or remote communications station without a connection to a mobile phone.

Electronics circuit 308 is further shown to include a telephone module 312 and an active noise cancellation module 202. Telephone module 312 is configured to use transceiver 310 and one or more of the interfaces 302, 304, 306 to effect an in-vehicle telephone feature. Active noise cancellation module 202 is configured to provide a noise cancellation or antinoise feature using one or more of the interfaces 302, 304, 306.

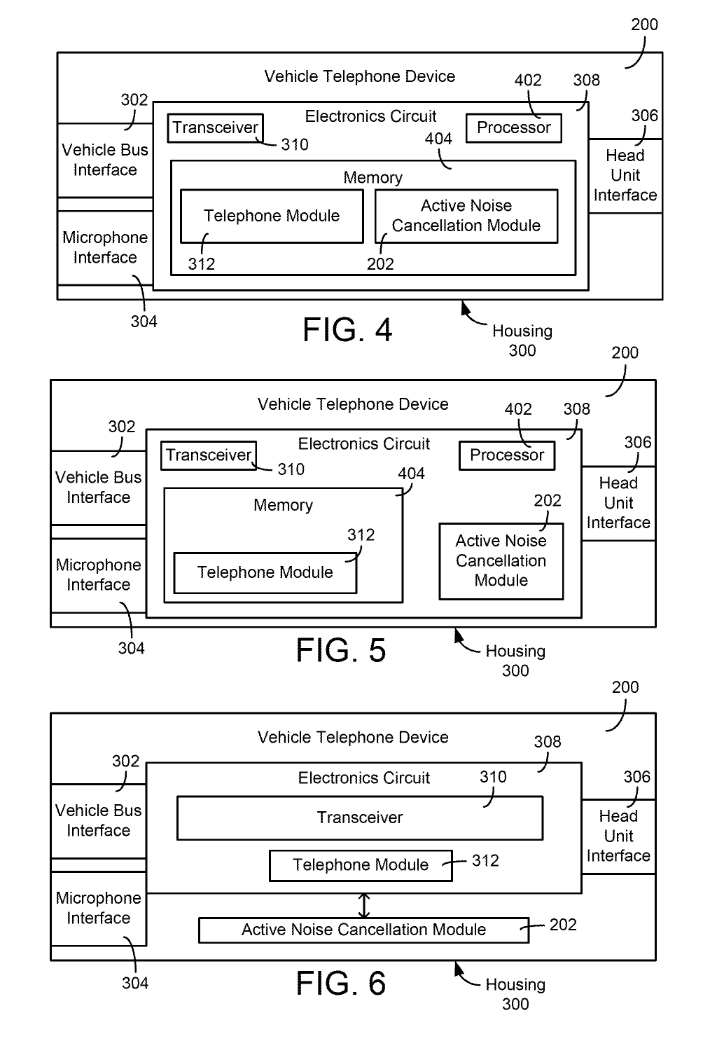

Referring now to FIGS. 4-6, differing embodiments of vehicle telephone device 200 are illustrated. The embodiment of FIG. 4 illustrates telephone module 312 and active noise cancellation module 202 as residing in memory 404 as software modules. Electronics circuit 308 of FIG. 4 includes a processor 402 and memory 404. Processor 402 can be implemented as a general purpose processor, an application specific integrated circuit (ASIC), one or more field programmable gate arrays (FPGAs), a group of processing components, or other suitable electronic processing components. Memory 404 is one or more devices (e.g., RAM, ROM, flash memory, hard disk storage, etc.) for storing data and/or computer code for completing and/or facilitating the various processes or steps described in the present disclosure. Memory 404 may be or include volatile memory or non-volatile memory. Memory 404 may include database components, object code components, script components, or any other type of information structure for supporting the various activities and information structures described in the present disclosure. According to an exemplary embodiment, memory 404 is communicably connected to processor 402 via the electronics circuit 308 and includes computer code for executing (e.g., by the processing electronics and/or processor) one or more processes described herein. In the embodiment of FIG. 4, for example, telephone module 312 is a computer code module for execution by processor 402 to provide the in-vehicle telephone feature as described herein. Active noise cancellation module 202 is a computer code module for execution by the processor 402 to provide the active noise cancellation feature as described herein.

In the embodiment of FIG. 5, memory 404 includes telephone module 312 implemented via a computer code (i.e., software) module, and active noise cancellation module 202 is implemented as a discrete chip-based module (e.g., integrated circuit, FPGA, etc.) coupled to electronics circuit 308.

In the embodiment of FIG. 6, electronics circuit 308 communicates with active noise cancellation module 202 via, e.g., a wired connection, but electronics circuit 308 does not include active noise cancellation module 202.

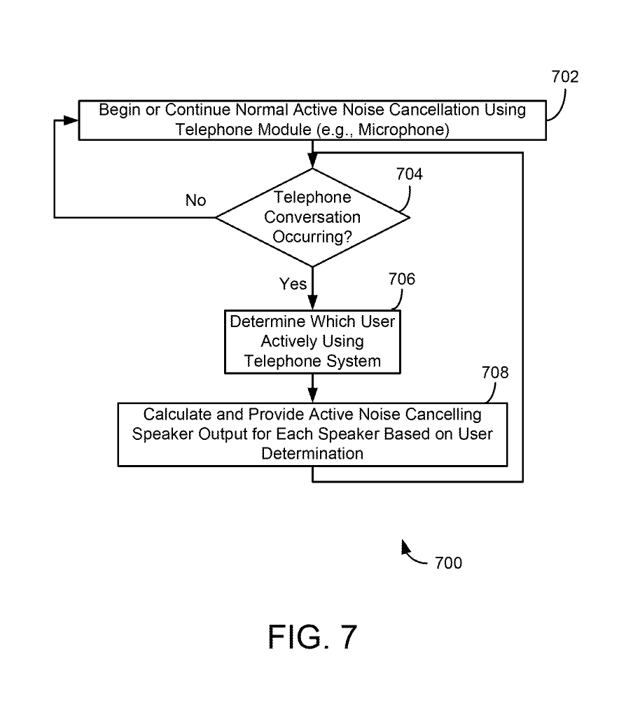

Referring now to FIG. 7, a flow chart of an active noise cancellation process 700 of the vehicle telephone device is shown, according to an exemplary embodiment. Process 700 may be executed by, for example, the active noise cancellation module 202 of FIGS. 2-6.

Process 700 includes beginning or continuing normal active noise cancellation using the telephone module and connected components such as the microphone (step 702). Step 702 may include determining a noise component to audio received at a connected microphone (e.g., wind noise, engine noise, road noise, braking noise, or any other type of low, medium or high frequency background noise), and generating an audio signal calculated to result in audio output having an inverted phase relative to the determined noise component. Normal active noise cancellation may be provided when there is no other noise such as a telephone conversation in the vehicle.

Process 700 further includes determining if a telephone conversation is occurring (step 704). The determination may be made by, for example, the vehicle telephone device 200 of FIGS. 2-6, and provided to the active noise cancellation module. If there is no telephone conversation, normal active noise cancellation may continue to be provided at step 702.

If a telephone conversation is occurring, process 700 includes determining which user is actively using the telephone system (step 706). In an exemplary embodiment, the vehicle includes a speaker for each seating location, and the speaker input of each speaker may be used to determine which user is actively using the telephone system. The user determination may be made by either the active noise cancellation module or by the vehicle telephone device that detects the telephone conversation.

Process 700 further includes calculating and providing an active noise canceling speaker output for each speaker based on the user determination (step 708). Active noise cancellation process 700 may be configured to provide different noise cancellation signals to the speaker of each vehicle seat depending on whether or not a telephone conversation is occurring at the vehicle seat. When a telephone conversation is occurring at a vehicle seat, a speaker output may be calculated that is configured to provide the best noise cancellation for the user at the seat actively using the telephone system. When the telephone conversation is complete, process 700 may be configured to switch from focusing noise cancellation efforts of the speaker on the user's noise levels (e.g., the activities of step 708) to distributing the noise cancellation efforts to each seat (e.g., the activities of step 702).

It should be noted that yet further embodiments are within the scope of the present disclosure. For example, active noise cancellation module 202 may be implemented primarily in software while telephone module 312 is implemented primarily via a separate chip or circuit. Combinations of the embodiments shown, in other words, are within the scope of the present disclosure.

As discussed above, the methods described herein may be computer-implemented methods and may be executed by one or more computer systems or electronic systems as described herein. Instructions for causing the computer systems to complete the activities of the above-described methods may be embodied on computer-readable media such as a CDROM, flash drive, or otherwise. All such embodiments of the invention are within the scope of the present disclosure.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. It should be understood that the present application is not limited to the details or methodology set forth in the description or illustrated in the figures. It should also be understood that the terminology is for the purpose of description only and should not be regarded as limiting.

1. A vehicle telephone device for mounting in a vehicle and for use with a vehicle audio system, a microphone mounted in the vehicle, and a mobile phone, comprising:
a housing;
a telephone module within the housing and configured to use the mobile phone, the microphone, and the vehicle audio system to provide an in-vehicle telephone feature; and
an active noise cancellation module within the housing and configured to use the vehicle audio system to cancel noise in the vehicle.

2. The vehicle telephone device of claim 1, wherein the telephone module and the active noise cancellation module share a common processor.

3. The vehicle telephone device of claim 1, wherein the telephone module and the active noise cancellation module share a common circuit board.

4. The vehicle telephone device of claim 1, wherein the telephone module and the active noise cancellation module share a common circuit within the housing.

5. The vehicle telephone device of claim 1, wherein the telephone module and the active noise cancellation module share an output interface to the audio system.

6. The vehicle telephone device of claim 1, wherein the telephone module and the active noise cancellation module share the microphone.

7. The vehicle telephone device of claim 1, wherein the telephone module and the active noise cancellation module utilize the microphone and least one additional microphone.

8. The vehicle telephone device of claim 1, wherein the telephone module uses the microphone as the primary microphone for detecting speech while the in-vehicle telephone feature is active; and
wherein the active noise cancellation module uses the microphone for noise cancellation while the microphone is being used as the primary microphone by the telephone module.

9. The vehicle telephone device of claim 8, wherein the active noise cancellation module uses the microphone as the primary microphone for the active noise cancellation module's noise cancellation feature when the telephone module is not using the microphone for the in-vehicle telephone feature.

10. The vehicle telephone device of claim 9, wherein the active noise cancellation module is configured to use at least one additional microphone or a group of microphones as the primary source for noise detection while the in-vehicle telephone feature is active.

11. The vehicle telephone device of claim 1, wherein the active noise cancellation module is configured to cause low frequency cancellation of engine noise using information provided from an engine control module (ECM).

12. The vehicle telephone device of claim 11, further comprising:
a vehicle subsystem interface for receiving the information provided from the ECM.

13. The vehicle telephone device of claim 11, wherein the active noise cancellation module is configured to cause the low frequency cancellation when the in-vehicle telephone feature is active and when the in-vehicle telephone feature is inactive.

14. The vehicle telephone device of claim 1, further comprising:
a module for providing human machine interface (HMI) features.

15. The vehicle telephone device of claim 1, further comprising at least one of:
a display module;
a vehicle navigation module;
a voice recognition module;
an audio decoding module; and
a user input device interface.

16. A vehicle system comprising:
a vehicle audio system;
at least one microphone;
a device comprising a housing;
an interface to the vehicle audio system; and
an interface to the at least one microphone;
wherein the device further comprises electronics within the housing, the electronics comprising a hands-free telephone module and an active noise cancellation module.

17. The vehicle system of claim 16, further comprising:
an interface for receiving information from at least one of a vehicle communications bus, a vehicle sensor, and a vehicle subsystem.

18. The vehicle system of claim 17, wherein the vehicle system receives information regarding engine operation via the interface.

19. The vehicle system of claim 18, wherein the hands-free telephone module is configured to use at least one of calculations and data from the active noise cancellation module to suppress or remove vehicle noise picked up by the at least one microphone during hands-free telephone functions.

20. The vehicle system of claim 19, wherein the active noise cancellation module predicts noise based on the information regarding engine operation and wherein the active noise cancellation module attempts to cancel the predicted noise; and wherein the hands-free telephone module uses the prediction of noise to suppress noise received at the microphone prior to sending audio to a mobile telephone for transmission as a part of a telephone call.
